(19) United States
(12) Patent Application Publication
(10) Pub. No.: US 2018/0336131 A1
(43) Pub. Date: Nov. 22, 2018

(54) Optimizing Memory/Caching Relative to Application Profile

(71) Applicant: Dell Products L.P., Round Rock, TX (US)

(72) Inventors: Lee B. Zaretsky, Pflugerville, TX (US); Farzad Khosrowpour, Pflugerville, TX (US)

(73) Assignee: Dell Products L.P., Round Rock, TX (US)

(21) Appl. No.: 15/600,963

(22) Filed: May 22, 2017

(51) Int. Cl. G06F 12/0811; G06F 12/0897

(52) U.S. Cl. CPC G06F 12/0811; G06F 2212/608; G06F 2212/1024; G06F 12/0897

(57) ABSTRACT

A system, method, and computer-readable medium are disclosed for optimizing performance of an information handling system comprising: profiling a plurality of applications based upon executing the applications on a particular information handling system, the particular information handling system including a tiered data and instruction cache architecture; identifying which of the plurality of applications are contained within a set of frequently used applications for a particular user; and, updating a tiered data and instruction cache architecture based upon the profiling.

### BACKGROUND OF THE INVENTION

### Field of the Invention

The present invention relates to information handling systems. More specifically, embodiments of the invention relate to optimizing memory and/or cache relative to application profile.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With information handling systems, it is known to attempt to optimize the placement of data relative to compute engines (e.g., CPU cores, accelerators, embedded controllers, etc.) which generate and consume this data.

### SUMMARY OF THE INVENTION

A system, method, and computer-readable medium are disclosed for optimizing performance of an information handling system comprising: profiling a plurality of applications based upon executing the applications on a particular information handling system, the particular information handling system including a tiered data and instruction cache architecture; identifying which of the plurality of applications are contained within a set of frequently used applications for a particular user; and, updating a tiered data and instruction cache architecture based upon the profiling.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a memory optimization environment.

FIG. 3 shows a block diagram of a memory architecture.

FIG. 4 shows a flow chart of the operation of a memory optimization operation.

FIG. 5 shows a flow chart of an application profile generation operation.

FIG. 6 shows a flow chart of a cache tiering management operation.

### DETAILED DESCRIPTION

A system, method, and computer-readable medium are disclosed for performing a memory optimization operation. In various embodiments, the memory optimization operation uses application profiling to provide enhanced structuring and updating of a tiered data and instruction caching architecture. In various embodiments, the memory optimization operation treats the tiered data and instruction caching architecture as a single contiguous storage container.

In various embodiments, the memory optimization operation recognizes that with typical client information handling system use cases, very few applications are most frequently used or have high priority to a user from performance perspective. For the purposes of this disclosure, very few applications may be defined as five or fewer applications. In various embodiments, when performing the memory optimization operation, a user provides input regarding application priority for the particular user. In various embodiments, the user providing priority provides the memory optimization operation with context which is used when optimizing the storage priority for the tiered data and instruction caching architecture.

Various aspects of the present disclosure include an appreciation that the use of caching elements and the tiering of storage allows designers of information handling systems to balance the requirements of data locality with other conflicting constraints such as power demands, thermal management, product cost and physical size/weight. Such a balance affects the productivity of the end user, impacting their experience of performance and responsiveness of the system to their particular workload.

Various aspects of the present disclosure include an appreciation that certain memory architectures include block level hardware and/or software cache logic as well as file caching logic. Block level hardware or software cache logic often operate based on “most frequent” for write or “predicted” for read block transfer. Accordingly, with block level cache logic often at least two copies of data are maintained within the system. Such methods can be applied to both data and instructions. Most block caching has no application context. File caching logic often includes an additional complexity of the cache manager maintaining the integrity of file input/output (IO) information.

Various aspects of the present disclosure include an appreciation that certain memory architectures use tiering logic (i.e., multiple cache and memory levels). Often tiering logic is based on access patterns (e.g., a “hot” access pattern when information is frequently accessed or a “cold” access pattern when information is occasionally accessed). Memory tiering is usually either performed at a block level with no information about applications, or at a whole file level. Although memory tiering results in a single copy of data in the system, it can involve at least one complete movement of data from one media to another which is a highly expensive operation. Memory tiering is generally used for data placement and not used for instructions.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

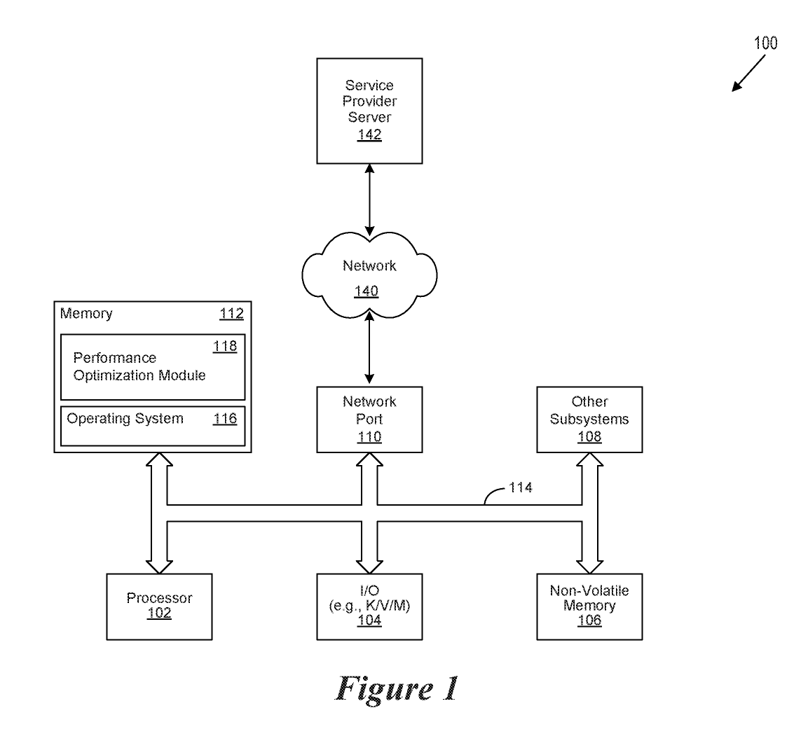

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a memory optimization module 118.

The memory optimization module 118 performs a memory optimization operation. The memory optimization operation improves the efficiency of the information handling system 100 by optimizing the performance of the information handling system when executing applications that make use of the memory architecture of the information handling system. As will be appreciated, once the information handling system 100 is configured to perform the memory optimization operation, the information handling system 100 becomes a specialized computing device specifically configured to perform the memory optimization operation and is not a general purpose computing device. Moreover, the implementation of the memory optimization operation on the information handling system 100 improves the functionality of the information handling system and provides a useful and concrete result of improving the performance of the information handling system when the information handling system 100 is executing applications.

In various embodiments, the memory optimization operation uses application profiling to provide enhanced structuring and updating of a tiered data and instruction caching architecture. In various embodiments, the memory optimization operation treats the tiered data and instruction caching architecture as a single contiguous storage container. In various embodiments, the memory optimization operation recognizes that with typical client information handling system use cases, very few applications are most frequently used or have high priority to a user from performance perspective. For the purposes of this disclosure, very few applications may be defined as five or fewer applications. In various embodiments, when performing the memory optimization operation, a user provides input regarding application priority for the particular user. In various embodiments, the user providing priority provides the memory optimization operation with context which is used when optimizing the storage priority for the tiered data and instruction caching architecture. Context could be provided by user, for example, that indicates a particular application or set of data must be handled at higher priority than others. This information would then be used when performing the memory optimization operation to manage data for this application at a high level of the tiering structure than might otherwise be determined by the memory optimization operation.

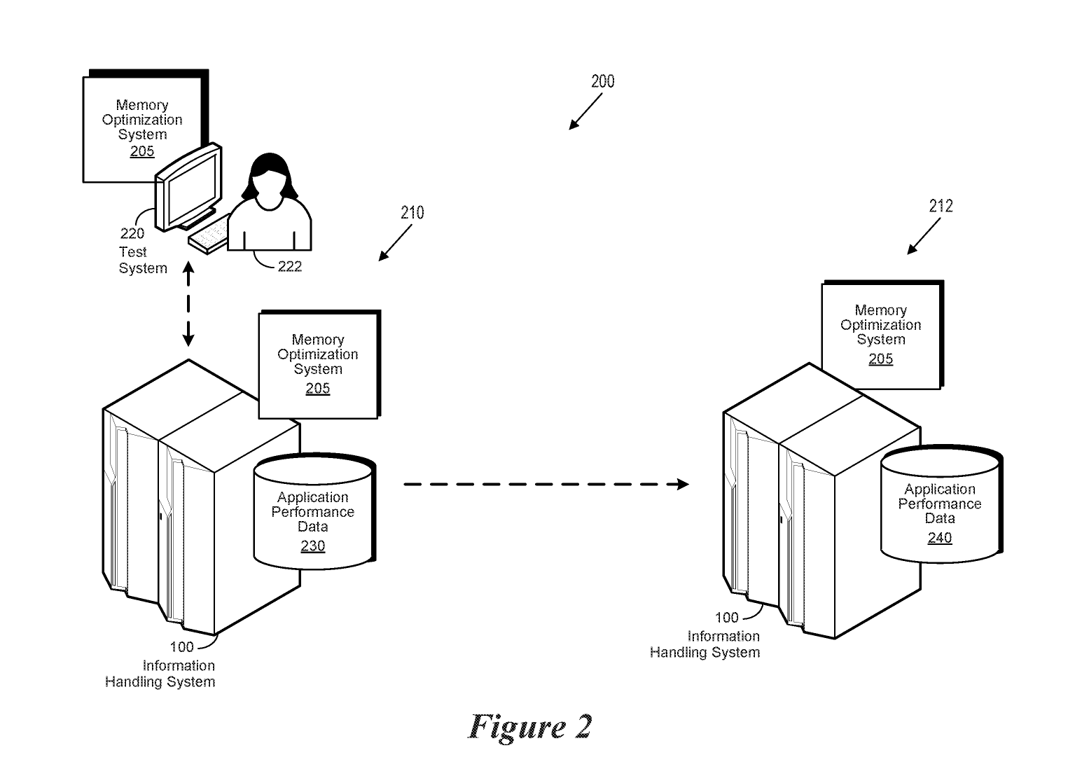

FIG. 2 shows a block diagram of a memory optimization environment 200. In various embodiments, the memory optimization environment 200 includes one or more memory optimization systems 205. Each memory optimization system 205 may perform some or all of a memory optimization operation.

The memory optimization environment 200 includes a developer portion 210 (which may also be a manufacturer portion) and a user portion 212. In various embodiments, the developer portion 210 includes a test system 220 (which may also be an information handling system 100) which interacts with the information handling system 100 for which the performance is being optimized. In various embodiments the developer portion 210 includes a repository of memory performance data 230. In certain embodiments, the information handling system for which the performance is being optimized includes application specific system configuration options. In certain embodiments, the application specific system configuration options include memory architecture configuration options. The user portion 212 includes an information handling system 100 which corresponds to some or all of the application specific system configuration options of the information handling system 100 from the developer portion 210. In various embodiments the user portion 212 includes a repository of application performance data 240.

The memory optimization operation addresses the data placement challenge in a new way by aligning memory optimization with the end users workload in a manner that provides an improved experience. The memory optimization operation includes a plurality of functional operations to configure and operate a memory architecture.

More specifically, in certain embodiments, the memory optimization operation includes a cache structure identification operation. The cache structure identification operation identifies and enumerates memory and local storage elements that are available for caching. When performing the cache structure identification operation, the memory optimization system identifies available elements that are usable as part of a tiered caching structure. In this context, “tiered caching” refers to an ordered structure of data storage elements that are specified to be allocated to data with differing frequencies of usage. This cache structure identification operation allows for system architectures to take advantage of multiple available technologies that could maximize performance (or minimize latency), or to reduce the caching structure to create a design that balances performance, cost, and energy.

In certain embodiments, the memory optimization operation includes an application profiling operation. The application profiling operation develops a representative set of characteristics associated with memory usage and storage space for an application. The memory usage and storage space can include size, access modes, data update frequency, and/or read and/or write ratio for the memory usage. The application profiling operation can be instantiated as a service or can include a utility running on the system. The target applications for which the application profiling operation are performed may be automatically selected based on those associated with the current user logged into the system or alternatively may be a specific subset selected by the user.

In certain embodiments, the memory optimization operation includes an alignment operation which aligns caching tiers with application profiles. Data relating to the target application is gathered on an ongoing basis. Based on gathered data for the targeted applications, application code information, data and/or key application metadata is placed in the appropriate tier of the caching structure. In certain embodiments, the application code information may be the actual code of an application and/or information detailing specifics about the nature of the application (which could be utilized to assist in the profiling process). In certain embodiments, the key application metadata is metadata which is specific and important to the operation of a particular application, and/or important to the profiling process. It is desirable to cache key application metadata in the appropriate tier with other data specific to the application. In certain embodiments, the alignment operation may be based upon a prioritized input from the user. In certain embodiments, the alignment operation may use algorithms to balance performance and responsiveness across a number of executing applications.

In certain embodiments, the memory optimization operation includes a prioritization operation which prioritizes and reallocates tiered cache environment. As the user proceeds through their workload activities, shifting demands for data and shifting focus among multiple applications trigger movement of data to higher or lower tiers (or out of the cache structure entirely). The alignment operation and the prioritization operation are part of an iterative process that continuously tunes data placements based on ongoing usage.

Applications may have file IO and/or block IO. Applications may have data transferred and/or managed at the file level (i.e., a unified structure related to a specific set of data for an application), or data may be split into blocks which tend to be uniform and agnostic of file structure. Depending on the computing environment, either or both types of IO may be utilized. In certain embodiments, a file system translation layer may be used to optimize the file to block IO mappings. Block Its traverses several driver stacks such as upper layer filter drivers, storage class drivers such as SCSI port and Storport, and transport specific block drivers and miniport drivers. In various embodiments, storage drivers can be at the block IO level (e.g., SCSIPort) or at the file IO level which includes a Kernel and a User level. Cache on the other hand is used to accelerate writes or reads avoiding the latencies issued by the storage media.

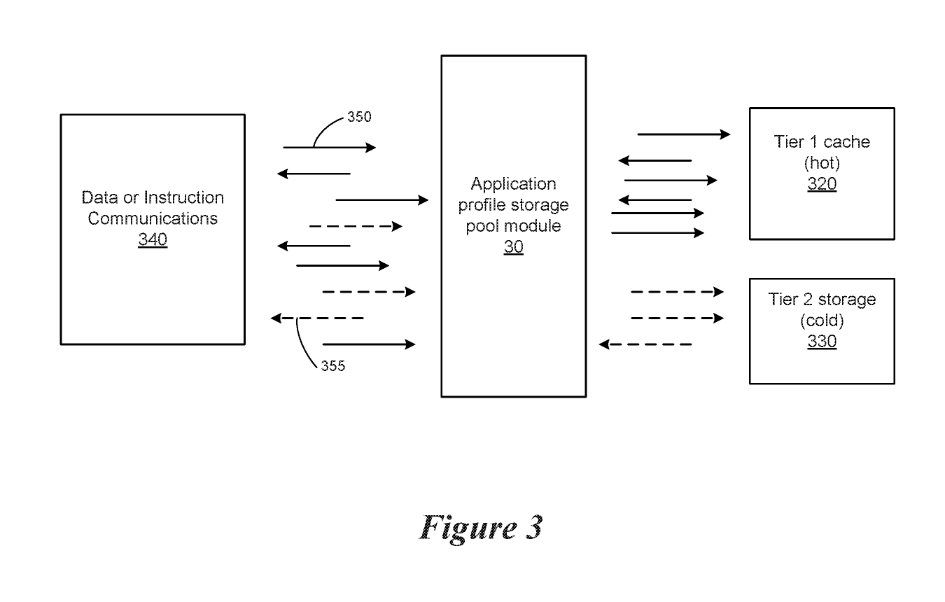

FIG. 3 shows a block diagram of a memory architecture 300. More specifically, the memory architecture 300 includes an application profile storage pool module 310 as well as a plurality of cache levels. In various embodiments, the plurality of cache levels includes a tier 1 cache 320 and tier 2 storage 330. In various embodiments, the tier 2 storage may comprise a second level cache. In various embodiments, the tier 2 storage may include other types of storage including random access memory (RAM) type storage and/or non-volatile type storage.

The application profile storage pool module 310 functions as a storage container which allows for redirection of IO communications 340 to a proper cache tier. Because the cache is a persistent storage, no additional duplicate copy or data movement is necessary. The IO can include data type IO as well as instruction type IO. Some of the IO communications may correspond to information which is frequently accessed (i.e., hot information) 350 and some of the IO communication may correspond to information which is occasionally accessed (i.e., cold information) 355. The relative difference between hot information and cold information is often application specific, and there may be multiple tiers of caching between hottest and coldest information. Thus, the use of the terms hot and cold may be considered to provide a heat index for data usage. The heat index is relative to the user and application environment. Heavy users versus occasional users of the similar data may have different heat indices. The memory optimization operation takes this relativity into account. Based upon an application profile associated with the application generating the IO communications, the application profile storage pool module 310 directs each IO communication to an appropriate memory tier. I.e., the application profile storage pool module 310 directs frequently access information 350 (indicated via solid lines) to a higher tier of the memory architecture and occasionally, accessed information 355 (indicated via dashed lines) to a lower tier of the memory architecture.

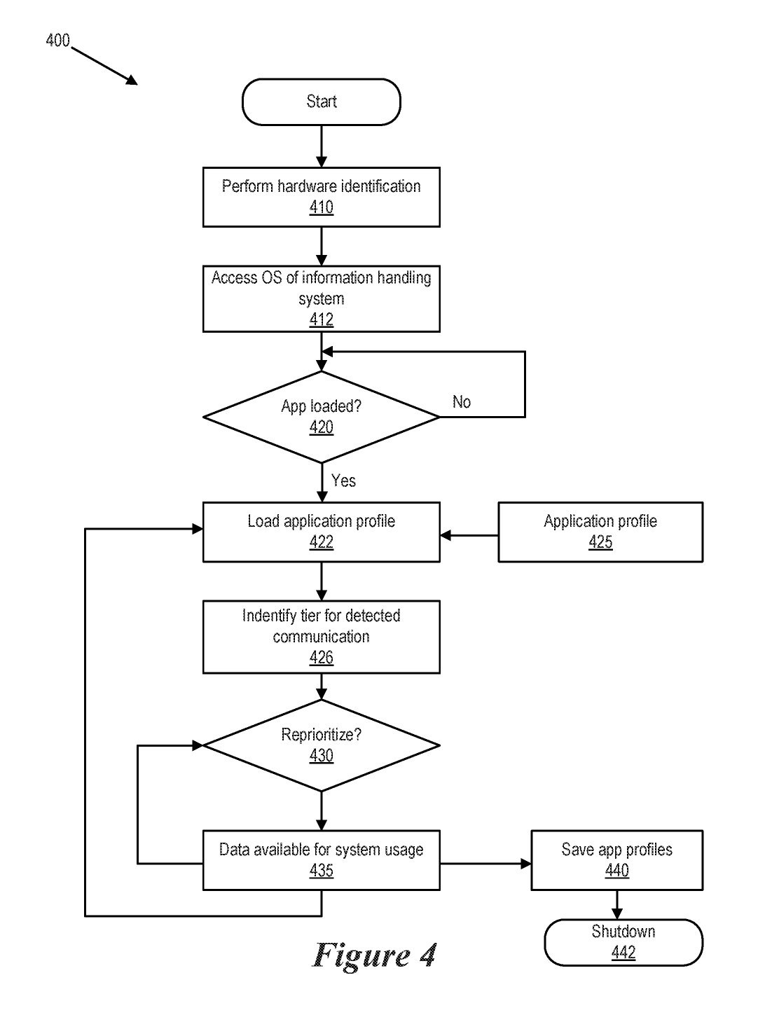

FIG. 4 shows a flow chart of the operation of a memory optimization operation 400. More specifically, the memory optimization operation 400 begins at step 410 by the memory optimization system 205 performing a hardware identification operation. During the hardware identification operation, the memory optimization system 205 identifies the memory and/or storage tiers of a particular type of information handling system. The hardware identification operation can also identify the capabilities and characteristics of each component of the storage architecture of the particular type of information handling system. Examples of capabilities and characteristics include performance parameters such as throughput, latency, utilization ratio (e.g., data vs instruction), size information (such as raw capacity, used capacity). If available these capabilities and characteristics can also include reliability data such as ECC protection, failure rates, etc. Next, at step 412, the memory optimization system 205 accesses the operating system of the particular type of information handling system to identify and enumerate the various storage tiers of the particular type of information handling system.

Next, at step 420, the memory optimization system 205 determines whether an application is loaded. If no application has been loaded, then the memory optimization system 205 continues to monitor via step 420 whether an application is loaded. When an application is loaded, the memory optimization system 205 proceeds to step 422 to load an application profile 425 corresponding to the application that was loaded. In various embodiments, the application profile provides a relative measure of how an application utilizes system resources such as storage. Whether the application uses mostly transactional storage, streaming read, large block writes etc. JO behavior of a storage can then be mapped to the application profile and memory optimization can be based at least in part on the priority of the application. Next, at step 424, the memory optimization system 205 detects a communication to and/or from the application and at step 426 identifies an appropriate cache tier for the detected communication based on the application profile.

Next, at step 430, the memory optimization system 205 determines whether it is necessary or desirable to reprioritize data tiering based upon application profile content (i.e., content contained within the application profile). If it is not necessary or desirable to reprioritize data tiering, then the memory optimization system 205 provides access to the data available in the various memory tiers for system usage at step 435. While the application is executing, the memory optimization system 205 iteratively returns to step 430 to determine whether it is necessary or desirable to reprioritize data tiering. Additionally, during step 430, the memory optimization system 205 determines whether a new application is loaded for execution on the information handling system or whether a system shutdown is initiated. If a new application is loaded, the memory optimization system 205 returns to step 422 to load an application profile corresponding to the application that was loaded. If a system shutdown is initiated, then the memory optimization system 205 saves the application profiles, saves the metadata associated with each application profile and flushes the information from the various memory tiers at step 440. The memory optimization system 205 then completes the shutdown at step 442.

If at step 430, the memory optimization system 205 determines it is necessary or desirable to reprioritize data tiering, then the memory optimization system 205 performs a reprioritize operation 450. As frequency of usage (hot vs cold) changes, or as priority is shifted from one application to another (which could be set by user for example), data may need to shift to different tiers to align data access with higher or lower latency memory.

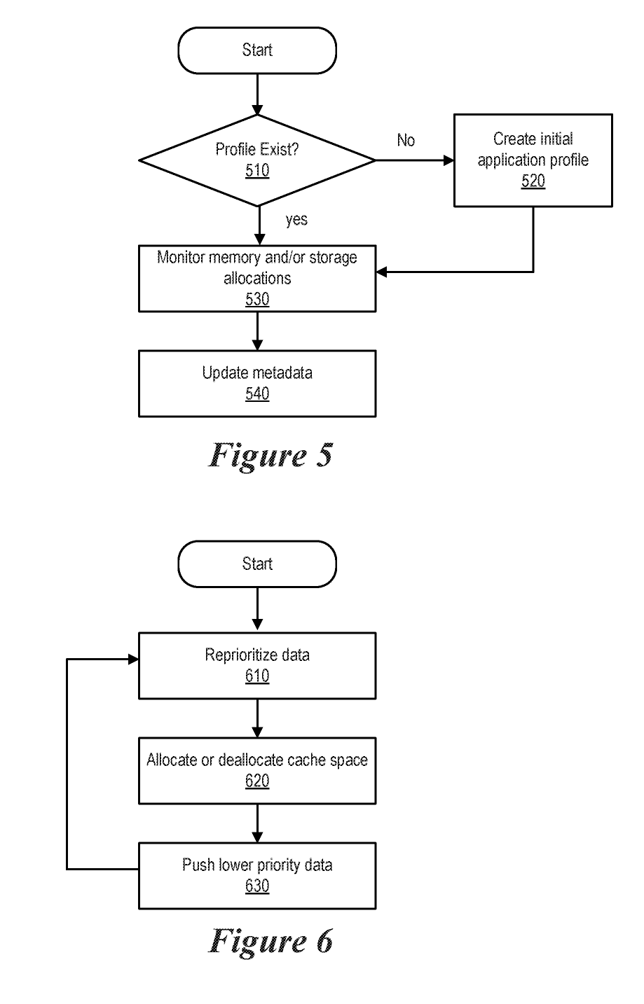

FIG. 5 shows a flow chart of an application profile generation operation 500. More specifically, the application profile generation operation 500 begins at step 510 by determining whether an application profile for a particular application exists. If not, then at step 520, the memory optimization system 205 creates an initial application profile for the application. The initial application profile provides a location where application profile metadata may be stored for the particular application profile. The profile metadata includes information regarding how an application associated with the metadata uses the system resources. After the initial application profile is created or if at step 510 the memory optimization system 205 determines that an application profile exists, then the memory optimization system 205 monitors memory and/or storage allocations and usage for the particular application executing on a particular information handling system at step 530. The memory optimization system 205 then updates the metadata contained within the application profile as needed at step 540. This application profile is what is provided at application profile 425 when a new application is loaded to the information handling system (e.g., as detected at step 424).

FIG. 6 shows a flow chart of a cache tiering management operation 600. More specifically, the cache tiering management operation 600 begins at step 610 by reprioritizing data. The reprioritizing data can include reprioritizing certain data as hot data and/or certain data as cold data. For example, if certain data is more frequently, accessed than when previously prioritized, this data may be reprioritized from cold to hot. Also for example, if certain data is less frequently access than when previously prioritized, this data may be reprioritized from hot to cold. In certain embodiments, prioritization is a function of the available cache structure as defined during a system initialization operation.

Next, at step 620, the cache tiering management operation 600 allocates or deallocates cache space as needed. In certain embodiments, the allocation or deallocation may be based upon whether more data is prioritized as hot or cold during the reprioritization step 610. In various embodiments, one or more of cache hit/miss ratios, cache read/write ratios, and cache utilization are used as indicators of the cache effectiveness. For example, a high read cache ratio coupled with a high cache miss may indicate a larger read cache size is beneficial to the memory optimization operation. Next, at step 630 the cache tiering management operation might push lower priority data to a lower cache tier or even out of the cache entirely based upon the reprioritization. In certain embodiments, the reallocation relates to the application profile based upon the specific needs of the application and user workload. The operation then returns to step 610 to interatively reprioritize data based upon operation of the application. The reprioritized data information is also provided to step 430.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

1. A computer-implementable method for optimizing performance of an information handling system comprising:
profiling a plurality of applications based upon executing the applications on a particular information handling system, the particular information handling system including a tiered data and instruction cache architecture;
identifying which of the plurality of applications are contained within a set of frequently used applications for a particular user;
receiving input from a particular user regarding application priority for the set of frequently used applications for the particular user; and,
updating a tiered data and instruction cache architecture based upon the profiling and the input from the particular user.

2. The method of claim 1, further comprising:
treating the tiered data and instruction caching architecture as a single contiguous storage container.

3. (canceled)

4. The method of claim 1, wherein:
the input regarding application priority provides context, the context being used when optimizing storage priority for the tiered data and instruction caching architecture

5. The method of claim 1, wherein:
the tiered data and instruction cache architecture comprises an application profile storage pool module, the application profile storage pool module functioning as a storage container to allows for redirection of communications between an application and a cache tier based upon the updating.

6. The method of claim 1, wherein:
each of the plurality of applications has an associated application profile, the associated application profile storing application profile metadata, the application profile metadata includes information regarding how an application associated with the metadata uses the system resources.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
profiling a plurality of applications based upon executing the applications on a particular information handling system, the particular information handling system including a tiered data and instruction cache architecture;
identifying which of the plurality of applications are contained within a set of frequently used applications for a particular user;
receiving input from a particular user regarding application priority for the set of frequently used applications for the particular user; and,
updating a tiered data and instruction cache architecture based upon the profiling and the input from the particular user.

8. The system of claim 7, wherein:
treating the tiered data and instruction caching architecture as a single contiguous storage container.

9. (canceled)

10. The system of claim 7, wherein:
the input regarding application priority provides context, the context being used when optimizing storage priority for the tiered data and instruction caching architecture

11. The system of claim 7, wherein the instructions executable by the processor are further configured for:
the tiered data and instruction cache architecture comprises an application profile storage pool module, the application profile storage pool module functioning as a storage container to allows for redirection of communications between an application and a cache tier based upon the updating.

12. The system of claim 7, wherein:
each of the plurality of applications has an associated application profile, the associated application profile storing application profile metadata, the application profile metadata includes information regarding how an application associated with the metadata uses the system resources.

13. A non-transitory, computer-readable storage medium embodying computer program code, the computer program code comprising computer executable instructions configured for:
profiling a plurality of applications based upon executing the applications on a particular information handling system, the particular information handling system including a tiered data and instruction cache architecture;
identifying which of the plurality of applications are contained within a set of frequently used applications for a particular user;
receiving input from a particular user regarding application priority for the set of frequently used applications for the particular user; and,
updating a tiered data and instruction cache architecture based upon the profiling and the input from the particular user.

14. The non-transitory, computer-readable storage medium of claim 13, wherein:
treating the tiered data and instruction caching architecture as a single contiguous storage container.

15. (canceled)

16. The non-transitory, computer-readable storage medium of claim 13, wherein:
the input regarding application priority provides context, the context being used when optimizing storage priority for the tiered data and instruction caching architecture

17. The non-transitory, computer-readable storage medium of claim 13, wherein the computer executable instructions are further configured for:
the tiered data and instruction cache architecture comprises an application profile storage pool module, the application profile storage pool module functioning as a storage container to allows for redirection of communications between an application and a cache tier based upon the updating.

18. The non-transitory, computer-readable storage medium of claim 13, wherein:
each of the plurality of applications has an associated application profile, the associated application profile storing application profile metadata, the application profile metadata includes information regarding how an application associated with the metadata uses the system resources.
